(19) United States
(12) Patent Application Publication
(10) Pub. No.: US 2015/0289446 A1
(43) Pub. Date: Oct. 15, 2015

(54) Pivotal Line Holder

(71) Applicant: Randy A. Duvall, Las Vegas, NV (US)

(72) Inventor: Randy A. Duvall, Las Vegas, NV (US)

(21) Appl. No.: 14/687,558

(22) Filed: Apr. 15, 2015

Related U.S. Application Data
(60) Provisional application No. 61/979,938, filed on Apr. 15, 2014.

(51) Int. Cl. A01D 34/416

(52) U.S. Cl. CPC A01D 34/4166

(57) ABSTRACT

A trimmer line holder for a trimmer head contains a structural body, a circular hole, a first trimmer line receiving hole, a second trimmer line receiving hole, and a hollow space. The circular hole traverses through the structural body from a top surface to a bottom surface. A trimmer blade attachment member of a trimmer head is positioned in the circular hole. The first trimmer line receiving hole and the second trimmer line receiving hole traverse into the hollow space through the structural body. A first end of a trimmer line traverses into the first trimmer line receiving hole Likewise, a second end of the trimmer line traverses into the second trimmer line receiving hole. When the trimmer line is inserted, the trimmer line lies perpendicular to the trimmer blade attachment member.

The current application claims a priority to the U.S. Provisional Patent application Ser. No. 61/979,938 filed on Apr. 15, 2014.

### FIELD OF THE INVENTION

The present invention relates generally to the field of gardening appliances. More specifically, the present invention introduces a trimmer line holder to be used with trimmer lines.

### BACKGROUND OF THE INVENTION

Trimmer lines are a popular and effective means of trimming vegetation. Due to their narrow area, flexibility, and high rotation speeds, trimmer lines are able to effectively trim vegetation near hard surfaces. However, trimmer lines suffer from a disadvantage, primarily due to their inconvenience in installation. In most traditional devices, the trimmer head needs to be disassembled to a certain extent for the trimmer line to be installed. In some trimmer heads, the installation process requires the trimmer lines to be evenly wrapped around the rotational axis of the trimmer head. Also a considerable number of trimmer lines need to be fastened to a certain extent in order to function efficiently. Therefore, a certain level of expertise is required to install trimmer lines. The difficulty of installing trimmer lines has been recognized in the industry but has not been adequately addressed. In one such method of installing a trimmer line, the trimmer lines are installed into a holder that is located on the trimmer head. Although, installing trimmer lines to a trimmer head holder has had some success, such installation methods may not be a long term solution. For instance, if the trimmer line holder mechanism is within the trimmer head body, replacing the holder can be costly and also time consuming. Furthermore, if a single trimmer line holder is damaged, the damage can be significant in the overall efficiency of the trimmer head.

The objective of the present invention is to address the aforementioned issues. More specifically, the present invention introduces a pivotal line holder that can be conveniently installed onto a trimmer head which is designed to be used with trimmer blades. More specifically, the present invention is designed to receive a trimmer blade attachment member which is traditionally used to install trimmer blades. In contrast to traditional trimmer line holders, which require the user to roll the trimmer line around a spool, the present invention allows the user to conveniently insert the trimmer line into the trimmer line holder. Another significant advantage of the present invention is the ability to be easily replaced. More specifically, if a trimmer line is damaged, the user can simply remove the damaged trimmer line without unfolding the entire trimmer line.

### BRIEF DESCRIPTION OF THE DRAWINGS

FIG. 1 is a perspective view of a structural body of the present invention.

FIG. 2 is a front view of the structural body of the present invention.

FIG. 3 is a back view of the structural body of the present invention.

FIG. 4 is a bottom view of the structural body of the present invention.

FIG. 5 is another perspective view of the structural body, wherein the first trimmer line receiving hole and the second trimmer line receiving hole are illustrated.

FIG. 6 is a perspective view of the present invention, wherein a trimmer line is inserted into the structural body.

FIG. 7 is a front view of the present invention, wherein the trimmer line is partially inserted into the structural body.

FIG. 8 is a front view of the present invention, wherein the trimmer line is completely inserted into the structural body.

FIG. 9 is a back view of the present invention, wherein the trimmer line is completely inserted into the structural body.

FIG. 10 is an exploded view of a trimmer head, wherein the present invention is concentrically aligned with a trimmer blade attachment member.

FIG. 11 is a perspective view of the trimmer head, wherein the present invention is attached to the trimmer blade attachment member.

### DETAIL DESCRIPTIONS OF THE INVENTION

All illustrations of the drawings are for the purpose of describing selected versions of the present invention and are not intended to limit the scope of the present invention.

The present invention is a trimmer line holder which can be utilized on a trimmer head which is designed to receive trimmer blades. By utilizing the present invention, the user saves time in installing trimmer lines. Moreover, the present invention provides multiple uses for an existing trimmer head.

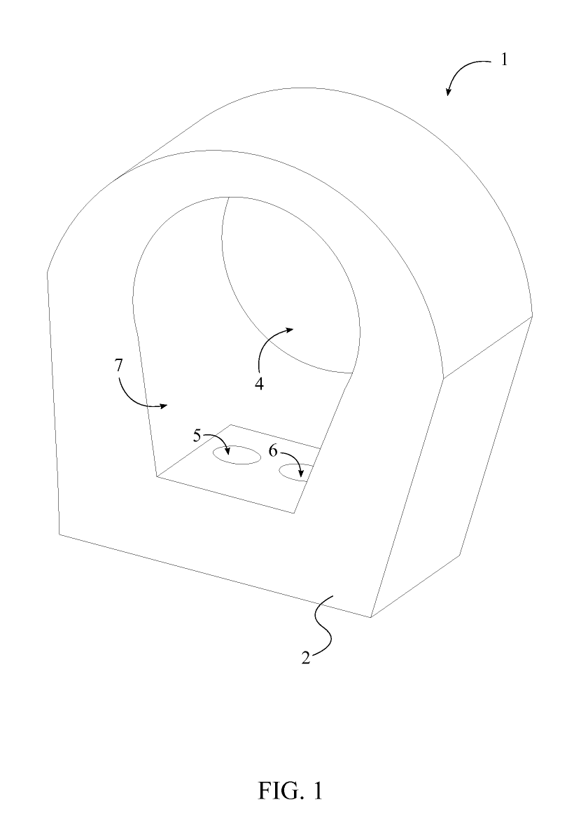

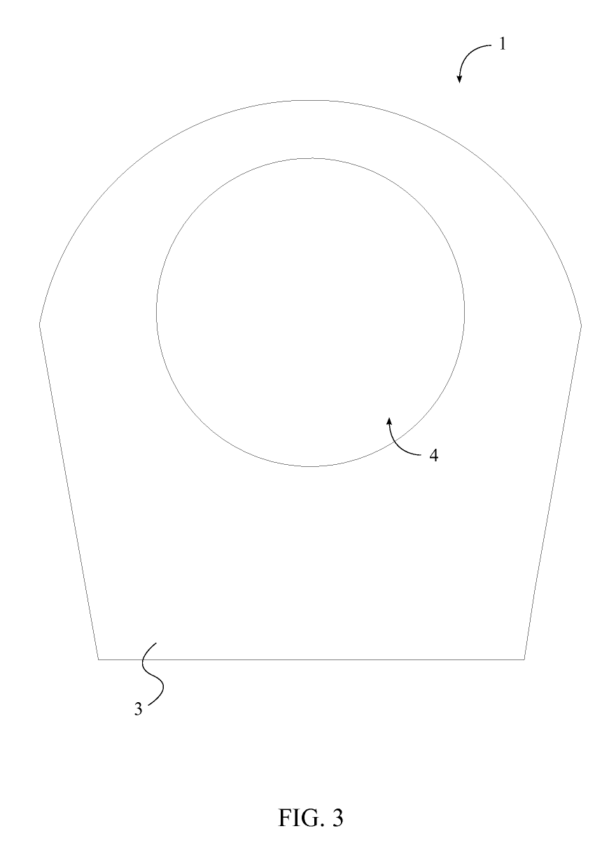

As illustrated in FIGS. 1-6, the present invention comprises a structural body 1, a circular hole 4, a first trimmer line receiving hole 5, a second trimmer line receiving hole 6, and a hollow space 7. The structural body 1 can be made of, but is not limited to, a lightweight material such as aluminum or plastic. The structural body 1 comprises a top surface 2 and a bottom surface 3, which lie flush against the two corresponding surfaces of a trimmer head 14. Being pressed against the two surfaces of the trimmer head 14 is important to eliminate any movement that can occur when the present invention is utilized on the trimmer head 14. The circular hole 4 traverses through the structural body 1 from the top surface 2 to the bottom surface 3 allowing the trimmer blade attachment member 13 to traverse through the thickness of the structural body 1. The circular hole 4 is sufficiently sized to receive a trimmer blade attachment member 13 and is also appropriately sized such that the trimmer blade attachment member 13 snugly fits within the circular hole 4. The close fit ensures that the present invention does not move relative to the trimmer blade attachment member 13 when used on the trimmer head 14.

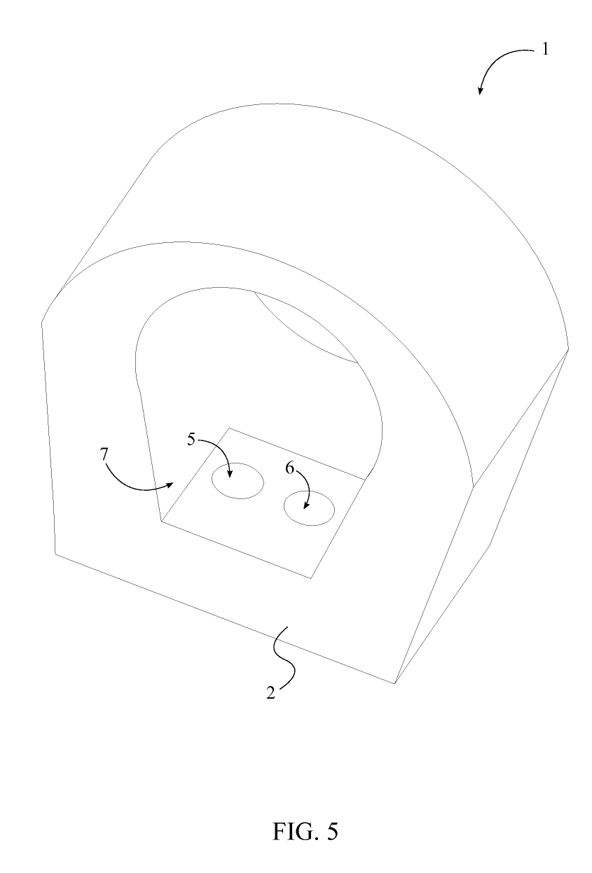

Prior to utilizing the present invention on the trimmer head 14, a trimmer line 8 is inserted into the first trimmer line receiving hole 5 and the second trimmer line receiving hole 6. The hollow space 7 allows the user to conveniently insert the trimmer line 8 into the first trimmer line receiving hole 5 and the second trimmer line receiving hole 6. More specifically, the hollow space 7 is intersected by the circular hole 4 such that the user has sufficient space to control and insert the trimmer line 8. As seen in FIG. 5, the hollow space 7 traverses into the structural body 1 through the top surface 2 and towards the bottom surface 3. Therefore, the user can position the trimmer line 8 between the top surface 2 and the bottom surface 3 when inserting the trimmer line 8.

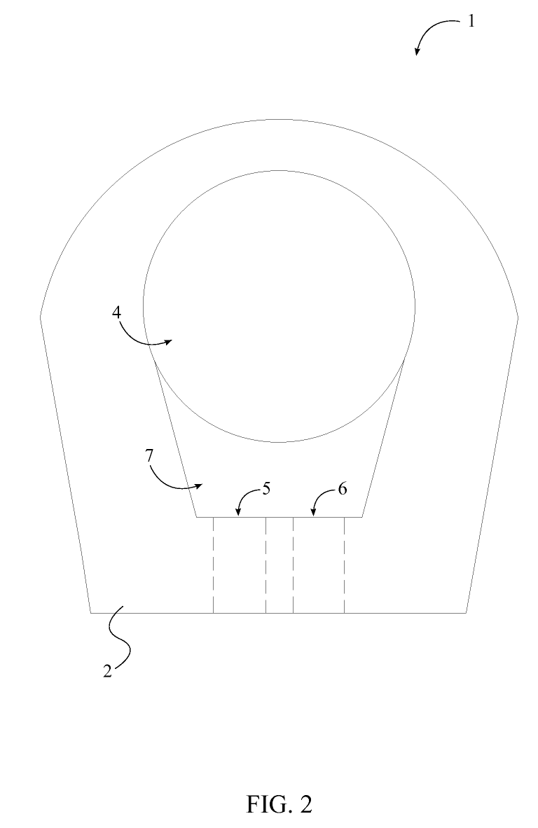

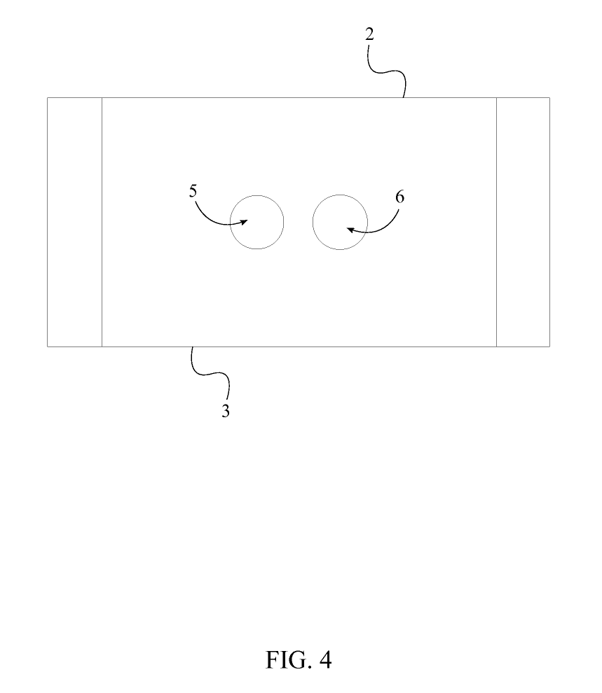

As seen in FIG. 4 and FIG. 5, the first trimmer line receiving hole 5 traverses into the hollow space 7 through the structural body 1. Similarly, the second trimmer line receiving hole 6 also traverses into the hollow space 7 through the structural body 1. As illustrated in FIG. 2, the first trimmer line receiving hole 5 and the second trimmer line receiving hole 6 are positioned perpendicular to the circular hole 4. The first trimmer line receiving hole 5 and the second trimmer line receiving hole 6 create a direct path for the trimmer line 8 to travel from the exterior of the present invention to the hollow space 7. Therefore, when the trimmer line 8 is inserted and the present invention is mounted onto the trimmer head 14, the trimmer line 8 lies perpendicular to the trimmer blade attachment member 13 and also lies at the same elevation as the structural body 1.

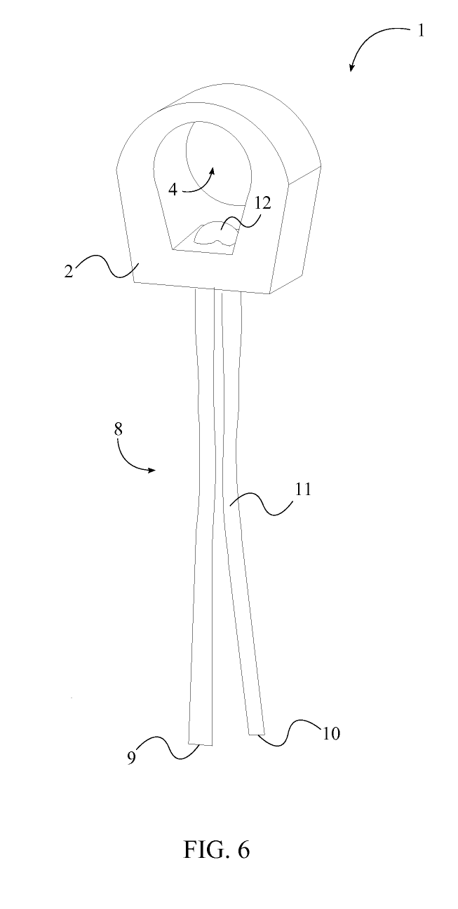

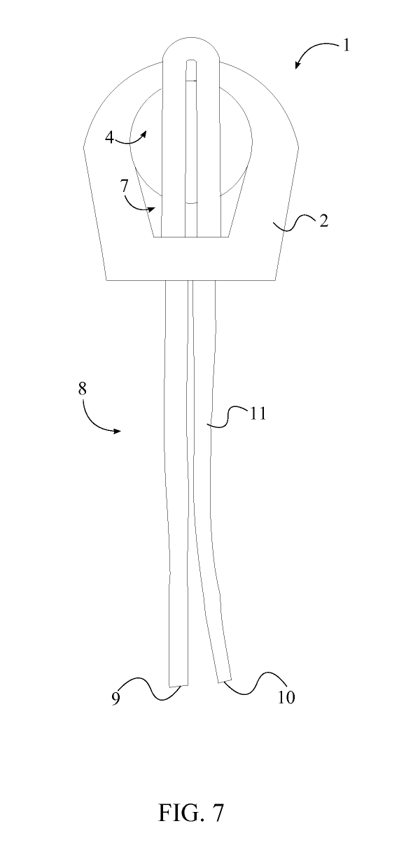

As illustrated in FIGS. 6-9, the trimmer line 8 comprises a first end 9, a second end 10, and a body 11. The body 11 extends from the first end 9 to the second end 10, and the length of the body 11 can vary in different embodiments of the present invention.

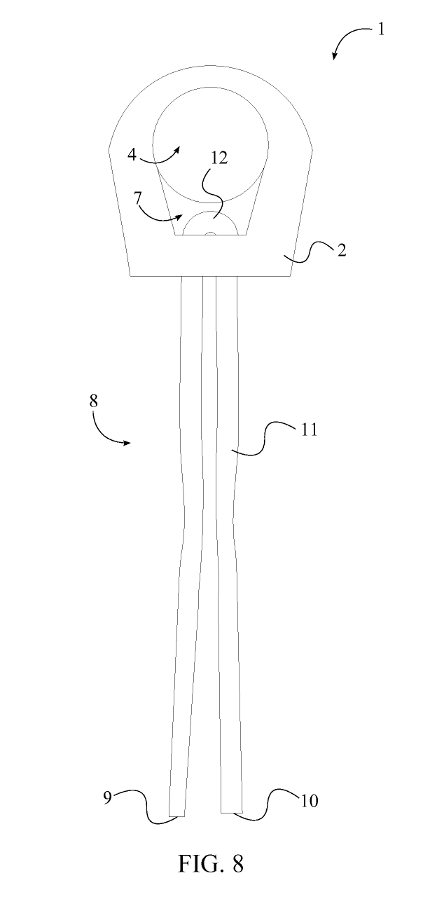

However, the length of the body 11 is chosen appropriately such that the trimmer line 8 is not extremely rigid or overly flexible. When the trimmer line 8 is inserted, the first end 9 traverses through the first trimmer line receiving hole 5. Likewise, the second end 10 traverses through the second trimmer line receiving hole 6. As illustrated in FIG. 8, when the first end 9 is inserted into the first trimmer line receiving hole 5 and the second end 10 is inserted into the second trimmer line receiving hole 6, a bent section 12 of the body 11 is positioned within the hollow space 7 in between the top surface 2 and the bottom surface 3. Moreover, the bent section 12 of the body 11 is pressed against the hollow space 7 such that the trimmer line 8 is secured against the structural body 1. The present invention is intended to be used on trimmer heads that utilize trimmer blade attachment members. Therefore, it is essential for the trimmer line 8 to be in between the top surface 2 and the bottom surface 3 such that the trimmer line 8 does not add to the thickness of the structural body 1. More specifically, since the bent section 12 of the trimmer line 8 is pressed against the hollow space 7 in between the top surface 2 and the bottom surface 3, the trimmer line 8 and the structural body 1 are positioned at the same elevation. More specifically, the first end 9 and the second end 10 are positioned coplanar with the structural body 1. In the preferred embodiment of the present invention, the trimmer line 8 extends from the structural body 1 up to a distance of approximately 12-18 inches.

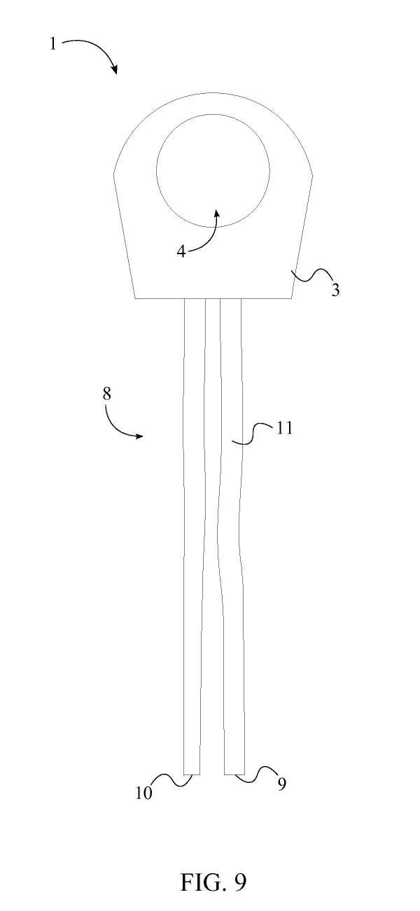

As seen in FIG. 8 and FIG. 9, when insertion of the trimmer line 8 is complete, the first end 9 is radially oriented away from the circular hole 4. Similarly, the second end 10 is also radially oriented away from the circular hole 4. The distance from the circular hole 4 to the first end 9 and the second end 10 depends on the length of the body 11. The first trimmer line receiving hole 5 and the second trimmer line receiving hole 6 are positioned parallel and adjacent to each other which leads to the first end 9 and the second end 10 being positioned adjacent to each other. The adjacent positioning of the first end 9 and the second end 10, maximizes efficiency since the overall surface area covered by the trimmer line 8 is increased. In the preferred embodiment of the present invention the first trimmer line receiving hole 5 and the second trimmer line receiving hole 6 are positioned ⅛ of an inch apart. Therefore, the first end 9 and the second end 10 are also positioned approximately ⅛ of an inch apart.

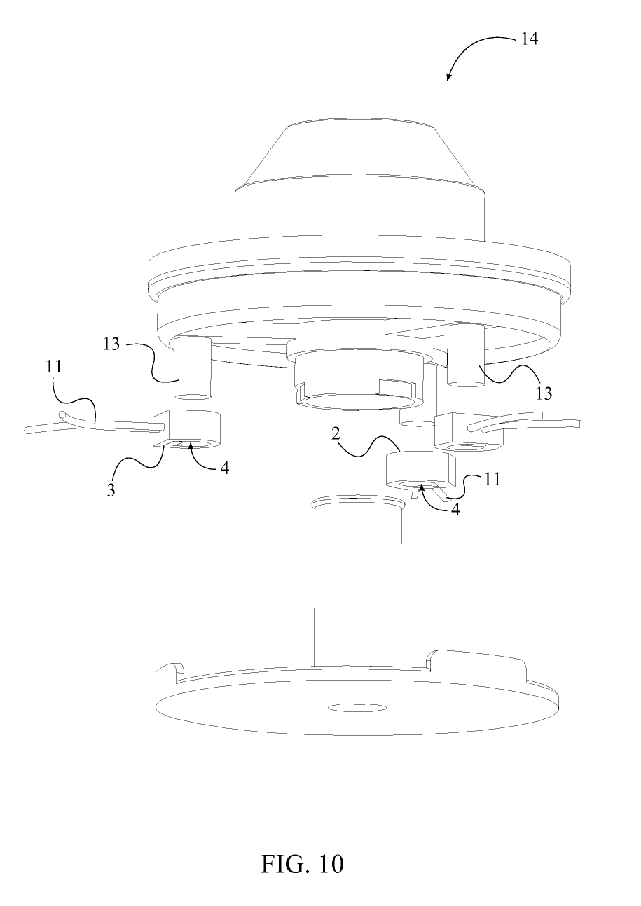

As discussed earlier, the circular hole 4 is designed to receive the trimmer blade attachment member 13. As illustrated in FIG. 10, when the present invention is utilized on the trimmer head 14 with the trimmer blade attachment member 13, the trimmer blade attachment member 13 concentrically traverses through the circular hole 4. As a result, the present invention establishes a secure connection with the trimmer head 14. The circular hole 4 is positioned opposite to both the first trimmer line receiving hole 5 and the second trimmer line receiving hole 6. Therefore, when the trimmer line 8 is inserted and the trimmer blade attachment member 13 is positioned within the circular hole 4, the first end 9 and the second end 10 can pivot about the trimmer blade attachment member 13. When the present invention is in use, trimming requirements are satisfied through the pivoting motion of the first end 9 and the second end 10, and the rotational motion of the trimmer head 14.

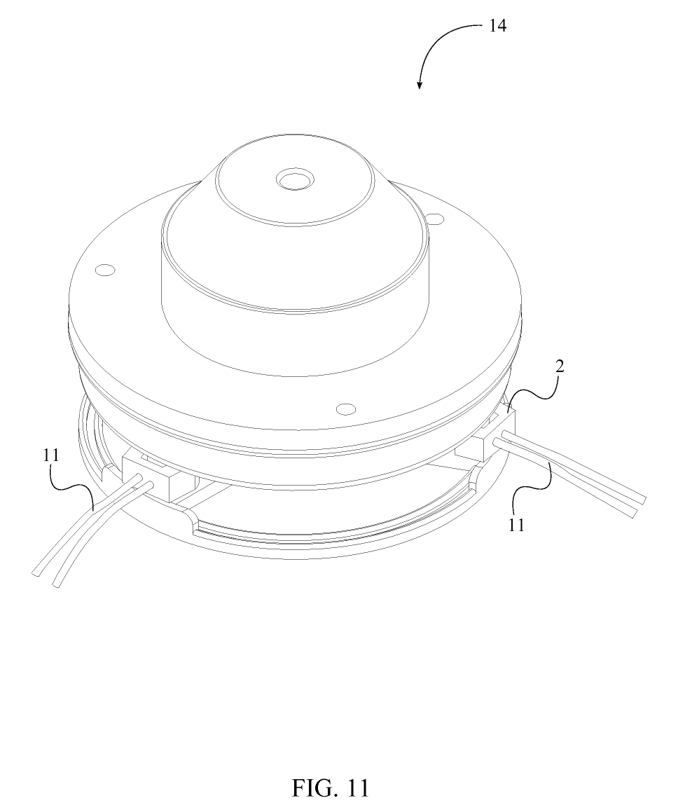

When utilizing the present invention the following process flow is followed. As an initial step, the trimmer line 8 is inserted into the first trimmer line receiving hole 5 and the second trimmer line receiving hole 6. In doing so, the first end 9 is inserted into the first trimmer line receiving hole 5 such that the first end 9 traverses through the structural body 1. Likewise, the second end 10 is inserted into the second trimmer line receiving hole 6 such that the second end 10 traverses through the structural body 1. Subsequently, the user grasps both the first end 9 and the second end 10 and pulls the trimmer line 8 away from the structural body 1. As a result, the bent section 12 of the body 11 is pressed against the hollow space 7 and positioned in between the top surface 2 and the bottom surface 3. When installation of the trimmer line 8 is complete, the present invention is then installed on the trimmer head 14. In doing so, the trimmer blade attachment member 13 is concentrically aligned with the circular hole 4. Next, as illustrated in FIG. 11, the trimmer blade attachment member 13 is positioned within the circular hole 4 such that the present invention establishes a secure connection with the trimmer head 14. When the trimmer is in use, the first end 9 and the second end 10 have a pivotal motion about the trimmer blade attachment member 13. The body 11 of the trimmer line 8 suffices the trimming requirements.

Although the invention has been explained in relation to its preferred embodiment, it is to be understood that many other possible modifications and variations can be made without departing from the spirit and scope of the invention as hereinafter claimed.

What is claimed is:

1. A pivotal trimmer line holder for a trimmer head comprises:
a structural body;
a circular hole;
a first trimmer line receiving hole;
a second trimmer line receiving hole;
a hollow space;
the structural body comprises a top surface and a bottom surface;
the circular hole traversing through the structural body from the top surface to the bottom surface;
the hollow space traversing into the structural body through the top surface and towards the bottom surface;
the first trimmer line receiving hole traversing into the hollow space through the structural body;
the second trimmer line receiving hole traversing into the hollow space through the structural body;
the first trimmer line receiving hole and the second trimmer line receiving hole being positioned parallel and adjacent to each other;
the first trimmer line receiving hole and the second trimmer line receiving hole being positioned perpendicular to the circular hole; and
the circular hole being positioned opposite to both the first trimmer line receiving hole and the second trimmer line receiving hole.

2. The pivotal trimmer line holder for a trimmer head as claimed in claim 1 comprises:
a trimmer line;
the trimmer line comprises a first end, a second end, and a body;
the body being extended from the first end to the second end;
the first end traversing through the first trimmer line receiving hole;
the second end traversing through the second trimmer line receiving hole; and
a bent section of the body being positioned within the hollow space in between the top surface and the bottom surface.

3. The pivotal trimmer line holder for a trimmer head as claimed in claim 2, wherein the first end and the second end are positioned coplanar with the structural body.

4. The pivotal trimmer line holder for a trimmer head as claimed in claim 2, wherein the bent section is pressed against the hollow space.

5. The pivotal trimmer line holder for a trimmer head as claimed in claim 2 comprises:
the first end being radially oriented away from the circular hole;
the second end being radially oriented away from the circular hole; and
the first end and the second end being positioned adjacent to each other.

6. The pivotal trimmer line holder for a trimmer head as claimed in claim 1 comprises:
a trimmer blade attachment member; and
the trimmer blade attachment member concentrically traversing through the circular hole.

7. The pivotal trimmer line holder for a trimmer head as claimed in claim 1, wherein the hollow space is intersected by the circular hole.

8. A pivotal trimmer line holder for a trimmer head comprises:
a structural body;
a circular hole;
a first trimmer line receiving hole;
a second trimmer line receiving hole;
a hollow space;
a trimmer line;
the structural body comprises a top surface and a bottom surface;
the circular hole traversing through the structural body from the top surface to the bottom surface;
the hollow space traversing into the structural body through the top surface and towards the bottom surface;
the first trimmer line receiving hole traversing into the hollow space through the structural body;
the second trimmer line receiving hole traversing into the hollow space through the structural body;
the first trimmer line receiving hole and the second trimmer line receiving hole being positioned parallel and adjacent to each other;
the first trimmer line receiving hole and the second trimmer line receiving hole being positioned perpendicular to the circular hole;
the circular hole being positioned opposite to both the first trimmer line receiving hole and the second trimmer line receiving hole;
the trimmer line comprises a first end, a second end, and a body;
the body being extended from the first end to the second end;
the first end traversing through the first trimmer line receiving hole;
the second end traversing through the second trimmer line receiving hole;
a bent section of the body being positioned within the hollow space in between the top surface and the bottom surface; and
the first end and the second end being coplanar with the structural body.

9. The pivotal trimmer line holder for a trimmer head as claimed in claim 7, wherein the bent section of the body is pressed against the hollow space.

10. The pivotal trimmer line holder for a trimmer head as claimed in claim 7 comprises:
the first end being radially oriented away from the circular hole;
the second end being radially oriented away from the circular hole; and
the first end and the second end being positioned adjacent to each other.

11. The pivotal trimmer line holder for a trimmer head as claimed in claim 7 comprises:
a trimmer blade attachment member; and
the trimmer blade attachment member concentrically traversing through the circular hole.

12. The pivotal trimmer line holder for a trimmer head as claimed in claim 7, wherein the hollow space is intersected by the circular hole.

13. A pivotal trimmer line holder for a trimmer head comprises:
a structural body;
a circular hole;
a first trimmer line receiving hole;
a second trimmer line receiving hole;
a hollow space;
a trimmer blade attachment member;
the structural body comprises a top surface and a bottom surface;
the circular hole traversing through the structural body from the top surface to the bottom surface;
the hollow space traversing into the structural body through the top surface and towards the bottom surface;
the first trimmer line receiving hole traversing into the hollow space through the structural body;
the second trimmer line receiving hole traversing into the hollow space through the structural body;
the first trimmer line receiving hole and the second trimmer line receiving hole being positioned parallel and adjacent to each other;
the first trimmer line receiving hole and the second trimmer line receiving hole being positioned perpendicular to the circular hole;
the circular hole being positioned opposite to both the first trimmer line receiving hole and the second trimmer line receiving hole; and
the trimmer blade attachment member concentrically traversing through the circular hole.

14. The pivotal trimmer line holder for a trimmer head as claimed in claim 12 comprises:
a trimmer line;
the trimmer line comprises a first end, a second end, and a body;
the body being extended from the first end to the second end;
the first end traversing through the first trimmer line receiving hole;
the second end traversing through the second trimmer line receiving hole; and
a bent section of the body being positioned within the hollow space in between the top surface and the bottom surface.

15. The pivotal trimmer line holder for a trimmer head as claimed in claim 14, wherein the first end and the second end are positioned coplanar with the structural body.

16. The pivotal trimmer line holder for a trimmer head as claimed in claim 13, wherein the bent section of the body is pressed against the hollow space.

17. The pivotal trimmer line holder for a trimmer head as claimed in claim 13 comprises:
the first end being radially oriented away from the circular hole;
the second end being radially oriented away from the circular hole; and
the first end and the second end being positioned adjacent to each other.

18. The pivotal trimmer line holder for a trimmer head as claimed in claim 12, wherein the hollow space is intersected by the circular hole.
